(19) United States
(12) Patent Application Publication
(10) Pub. No.: US 2018/0276530 A1
(43) Pub. Date: Sep. 27, 2018

(54) OBJECT RECOGNITION USING A SPIKING NEURAL NETWORK

(71) Applicant: INTEL CORPORATION, Santa Clara, CA (US)

(72) Inventors: Arnab Paul, Hillsboro, OR (US); Narayan Srinivasa, Portland, OR (US)

(73) Assignee: INTEL CORPORATION, Santa Clara, CA (US)

(21) Appl. No.: 15/468,881

(22) Filed: Mar. 24, 2017

(51) Int. Cl. G06N 3/04; G06N 3/08

(52) U.S. Cl. CPC G06N 3/049; G06N 3/08

(57) ABSTRACT

Embodiments described herein describe object recognition using a spiking neural network. Object recognition using a spiking neural network can include processing each of the plurality of base templates through a plurality of input neurons to generate a plurality of first spikes through the plurality of input neurons, providing the plurality of first spikes from the plurality of input neurons to each of a plurality of excitatory neurons (E-neurons), providing a plurality of second spikes from a plurality of inhibitory neurons (I-neurons) to the plurality of E-neurons to inhibit a spiking rate of the E-neurons, generating a plurality of weights at each of the plurality of E-neurons based on the plurality of first spikes and the plurality of second spikes, and classifying a pattern utilizing the plurality of input neurons, the plurality of E-neurons, and the plurality of weights at each of the E-neurons.

### TECHNICAL FIELD

The present disclosure relates to neural networks. In particular, the present disclosure relates to spiking neural networks.

### BRIEF DESCRIPTION OF THE DRAWINGS

FIG. 1 is a diagram illustrating a spiking neural network for object recognition according to various embodiments.

FIG. 2 is a diagram illustrating a spiking neural network for object recognition according to various embodiments.

FIGS. 3, 4, and 5 are flow diagrams illustrating methods for object recognition using a spiking neural network according to various embodiments.

FIG. 6 is a block diagram illustrating an example computing device suitable for use to practice aspects of the present disclosure, according to various embodiments.

FIG. 7 is a block diagram illustrating a storage medium having instructions for practicing methods described with references to FIGS. 1-5, according to various embodiments.

### DETAILED DESCRIPTION OF PREFERRED EMBODIMENTS

Spiking neural networks can be limited due to a number of factors. For example, in spiking neural networks, learning can occur in bulk mode. That is, learning can utilize training sets that are presented to the spiking neural network at once. In spiking neural networks the number of samples used to train the spiking neural networks can be large for each category or class of patterns.

Biological neural networks do not learn in a constrained fashion as described above. Learning can commence with a limited number of training samples and then proceed in a “correct-when-erred” manner.

As used herein, a spiking neuron network is a network comprised of spiking neurons and synapses. A spiking neuron can be a neuron that does not fire at every propagation cycle but rather fires only when a membrane potential reaches a specific value (e.g., threshold). A membrane potential is the difference between the electric potential of the interior and exterior of a biological cell.

In some embodiments, a spiking neuron can be implemented utilizing a software object referred to as a node (e.g., neuron). A synapse can be implemented utilizing a software object referred to as a link. The examples described herein can also be implemented utilizing a neural processor and/or a neural chip.

A number of examples describe a spiking neural network architecture for object recognition that is capable of learning complex patterns in an online manner. The spiking neural network can be a feed-forward and recurrent network. The spiking neural network can also be an excitatory-inhibitory (EI) network.

The spiking neural network can operate in at least two phases. A template-training phase and an online training phase.

The template-training phase can include an EI portion of the spiking neural network being turned on. During a template-training phase the spiking neural network can be presented with a set of carefully selected training patterns from which initial weight matrices can be learnt. In a template-training phase the spiking neural network can learn a set of base templates (e.g., templates) to create a new basis, such as a Fourier basis, for the corresponding patterns to be represented. A representation for various objects can be created. The representation can be invariant of natural changes of perspectives such as rotation (2D and 3D) changes and/or scaling changes, among other types of changes. The representation can be sufficiently discriminative to distinguish between different object types (e.g., classes).

An online training phase can include switching the spiking neural network to a feed-forward mode. The spiking neural network can be provided with a few training samples for every category of classification at first, after which the spiking neural network can be kept in a semi-supervised mode. A spiking neural network in a semi-supervised mode can continue to make inferences including erroneous inferences that can be corrected in an online fashion.

The online training phase can be divided into two phases, which are the second and third phases overall, following the template-training phase. For example, the second phase can compute invariant representations of a plurality of training samples. The third phase can deploy a trained spiking neural network for classification. The third phase can also include online learning guided by supervised error detection.

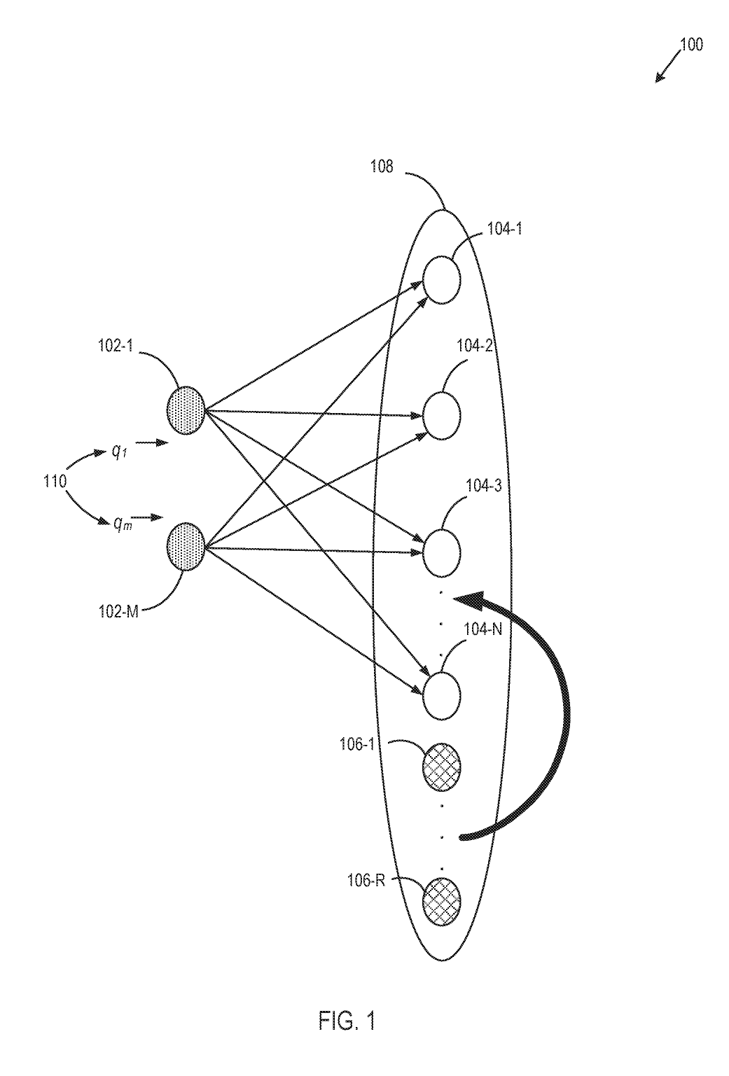

The spiking neural network in the template-training phase is shown in FIG. 1. The template-training phase can also be referenced as a first phase. In the template-training phase the spiking neural network can learn a set of base templates using by turning on both excitatory, as well as the inhibitory neurons, and thereby operating in a full EI mode. The spiking neural network can consist of a set of afferent neurons carrying the input patterns, a set of excitatory (e.g., E-neurons), and a set of inhibitory neurons (I-neurons).

The afferent neurons can be referenced as input neurons. The afferent neurons can connect to the E-neurons in a feed-forward manner through a plurality of links. That is, spikes can be provided from the afferent neurons to the E-neurons and not from the E-neurons to the afferent neurons.

The E-neurons and the I-neurons can comprise a single layer of the spiking neural network. This layer can have recurrent connection to itself. For example, the E-neurons and the I-neurons can be interconnected. The E-neurons can be coupled to each other to excite each other to increase the spiking rate of the E-neurons. The I-neurons can be coupled to the E-neurons to inhibit the spiking rate of the E-neurons.

The base templates are presented to the E-neurons over multiple iterations. Each of the base templates can be held as an input during each of the iterations for a threshold amount of time. The threshold amount of time can be configured by an input received by the spiking neural network.

The spiking neural network can learn the base templates in an unsupervised manner. That is, the spiking neural network can learn the base template without reference to classes associated with the base templates or by input provided to the spiking neural network. Learning includes capturing the templates as feed-forward weights between the afferent neurons and the E-neurons. The base templates can be selected based on a number of different schemes and/or projections.

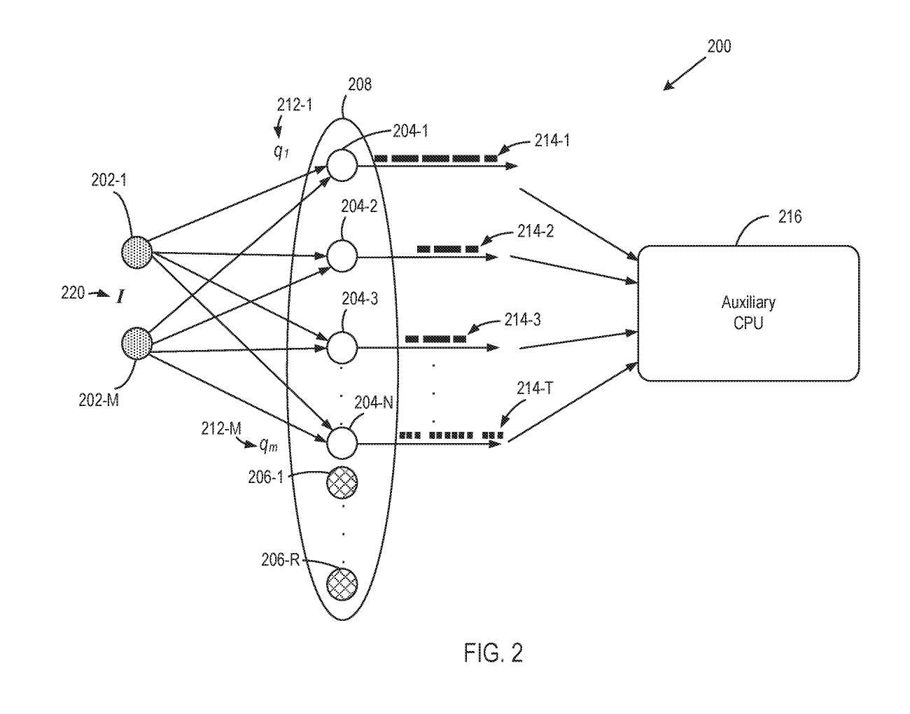

The second phase and the third phase are shown in FIG. 2. In the second phase, a plurality of training samples can be presented to the spiking neural network. The plurality of training samples can be associated with categories of objects. The I-neurons as well as incoming and outgoing connections to and from the I-neurons are turned off completely in the second phase.

The afferent neurons can carry the signals to the E-neurons through a plurality of links. The response of the E-neurons is modulated by weights learnt during the first phase. That is, in the second phase the afferent-neurons project the input patterns into a basis that was learnt during the first phase.

The membrane potential of each of the E-neurons can evolve according to the standard leaky integrate-and-fire (LIF) rule. In the LIF model, the memory of the spiking neural network can be time-dependent by adding a “leak” term to the membrane potential, reflecting the diffusion of ions that occurs through the membrane when some equilibrium is not reached in the cell. The LIF rule coupled with the presence of the weight matrix (W) that modulates the conductance trace (g(t)) of the pre-synaptic spikes of the afferent neurons.

The membrane time-constant can be represented by:

$${τ}_{m} \frac{dv}{dt} = ( {V}_{rest} - v ( t ) ) + {ℊ}^{T} . W ( E - v ( t ) )$$

In the above equation, τₘ represents the membrane time-constant. The conductance trace g(t) has an exponential decay as well, with a time constant τ_{g}. v(t) represents the membrane voltage as a function of time (t) and Vᵣₑₛₜ denotes the resting potential the membrane resets back to every time a spike occurs.

$$\frac{dv}{dt}$$

represents the instantaneous rate of change of the membrane potential v with respect to time t. g^{T} represents the transpose of the matrix capturing the conductance trace (g(t)). E is a constant membrane potential, that only depends on whether the neuron is excitatory or inhibitory nature.

The conductance evolves as:

$${ℊ}_{t + 1} = {δ}_{t + 1} + {ℊ}_{t} . {e}^{- \frac{t}{{τ}_{ℊ}}}$$

In this equation δₜ represents a delta function indicating if a spike occurred (e.g., δₜ=1) or if a spike did not occur (e.g., δₜ=0) during an instant.

Each E-neuron spikes whenever v(t)>V_{threshold}. That is, each E-neuron spikes when a voltage (e.g., v(t)) of the E-neuron is greater than a voltage threshold (e.g., V_{threshold}). Given M E-neurons, a vector of spiking rates p=(r₁, r₂, . . . r_{M}) can be computed. The rate vector of the E-neurons can be computed at an auxiliary central processing unit (CPU) to assist the neural chip with non-neural encoding/decoding activities.

For every object class c, a small number of training samples c₁, c₂, . . . cₖ, are presented. In some examples, k<<M. For each of these k samples, the invariant signatures ρ₁^{c}, ρ₂^{c}, ρₖ^{c} are computed, and stored as the representative signature set for the class c. The signatures remain stored in the memory of the auxiliary CPU.

In phase three, the spiking neural network can be deployed to perform pattern recognition. Every time a new pattern is provided to the spiking neural network, the spiking neural network can generate a response by evolving each E-neuron via the LIF rule. The invariant signature (ρ) can then be compared with the other class responses that are already stored. A class with the smallest distance to the invariant signature can selected as the class corresponding to the pattern. The class can be selected by:

class=argmin_{c}{∥ρ−ρₖ^{c}|₂}_{c,k}.

That is, the minimization is computed over every stored instance (k) of every class (c), and the c value for which the minimum is attained is chosen as the answer.

Online learning can take place if the answer is erroneous. That is, online learning can take place if a pattern is classified erroneously by the spiking neural network.

If the answers are supervised for some time, then, whenever a mistake is made, for a class c, the signature set can be updated as follows:

ρ^{c}←ρ^{c}∪ρ

The online learning step assisted by the auxiliary CPU can vastly improve the classification accuracy of the network.

FIG. 1 is a diagram illustrating a spiking neural network 100 for object recognition according to various embodiments. The spiking neural network 100 can include the input neurons 102-1 to 102-M, referred to generally as input neurons 102. The spiking neural network 100 can also include E-neurons 104-1, 104-2, 104-3, to 104-N, referred to generally as E-neurons 104. The spiking neural network 100 can also include I-neurons 106-1 to 106-R, referred to generally as I-neurons 106.

The input neurons 102 can receive a template 110. That is, the pixels (e.g., q₁ . . . qₘ) of the template can be provided as input to the input neurons 102. In some examples, each of the pixels of the template 110 can be provided to a different input neuron from the input neurons 102. In other examples, a portion of the pixels of the template 110 can be provided to the input neurons 102.

Although not shown, the E-neurons 104 can be coupled to each other. In some examples, the quantity of E-neurons 104 (e.g., N) can be equal to the quantity of input neurons 102 (e.g., M) such that N=M. However, N can be greater than M (N>M) or N can be less than M (N<M).

The I-neurons 106 are coupled to the E-neurons 104. The quantity (e.g., R) of I-neurons 106 can be equal to, greater than, or less than the quantity (e.g., N) of the E-neurons 104. The I-neurons 106 and the E-neurons 104 can comprise a single layer 108 of the spiking neural network 100.

A plurality of templates, including the template 110, can be provided to the spiking neural network 100 repetitively in a plurality of iterations. Each of the plurality of templates can be held as input for a predetermined period of time. The spiking neural network 100 can be trained to generate a plurality of weights (e.g., W) as shown in FIG. 2.

FIG. 2 is a diagram illustrating a spiking neural network 200 for object recognition according to various embodiments. The spiking neural network 200 can include the input neurons 202-1 to 202-M, referred to generally as input neurons 202. The spiking neural network 200 can also include E-neurons 204-1, 204-2, 204-3, to 204-N, referred to generally as E-neurons 204. The spiking neural network 200 can also include the I-neurons 206-1 to 206-R, referred to generally as I-neurons 206. The input neurons 202, the E-neurons 204, and the I-neurons 206 are analogous to the input neurons 102, the E-neurons 104, and the I-neurons 106 in FIG. 1, respectively. The spiking neural network 200 can also include an auxiliary CPU 216. As in FIG. 1, the E-neurons 204 and/or the I-neurons 206 comprise a single layer 208 of the spiking neural network 200.

In FIG. 2, the I-neurons 206 are deactivated. That is, the I-neurons 206 are not utilized in processing a training sample 220. The spiking neural network 200 can process the training sample 220 to generate a spiking rate vector. The spiking rate vector can include a plurality of spiking rates 214-1, 214-2, 214-3, to 214-T, referred to generally as spiking rates 214 and spiking rate vector 214. The spiking rate vector 214 can be a signature of the training sample 220 that can be used to classify the training sample 220 and train the neural network 200.

For example, the spiking rate vector 214 can be stored in the memory of the auxiliary CPU 216 along with other spiking rate vectors as a class. As such, each class (e.g., class of objects) can be associated with a plurality of spiking rate vectors.

The spiking neural network 200 can receive the training sample 220 through the input neurons 202. The input neurons 202 can provide a plurality of spikes to the E-neurons 204. Each of the input neurons 202 can be coupled to each of the E-neurons 204 through a plurality of links associated with a plurality of weights 212-1 to 212-M, referred to generally as weights 212 (e.g., qₘ). Each of the links can be associated with one of the plurality of weights 212. For example, a first link between the input neuron 202-1 and the E-neuron 204-1 can be associated with a weight 212-1, and a second link between the input neuron 202-1 and the E-neuron 204-1 can also be associated with the weight 212-1.

The weights 212 can be used to modulate the spikes generated by the input neurons 202 for the E-neurons 204. In some examples, the weights 212 can be equal to the base template 110 in FIG. 1. The E-neurons 204 can generate the spiking rate vector 214.

In some examples, FIG. 2 can also be used in phase three. That is, the spiking neural network 200 can be used to perform online training of the spiking neural network 200.

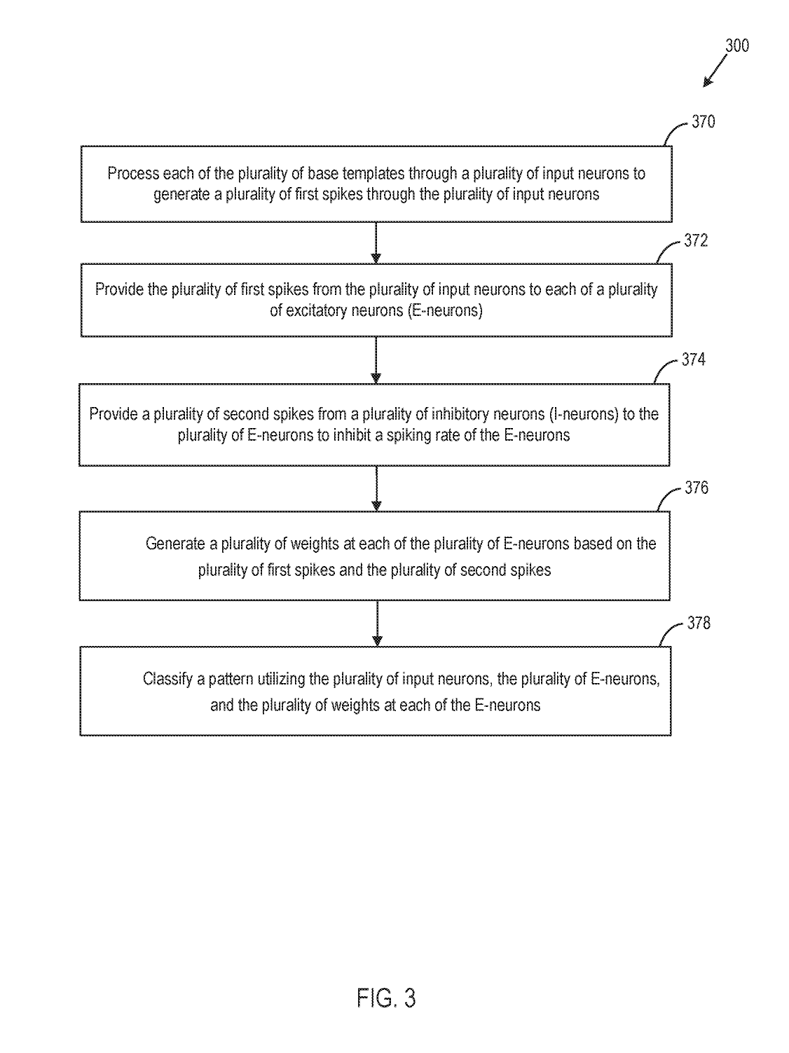

FIG. 3 is a flow diagram illustrating a method for object recognition using a spiking neural network according to various embodiments. The method 300 comprises processing 370 each of the plurality of base templates through a plurality of input neurons to generate a plurality of first spikes through the plurality of input neurons, providing 372 the plurality of first spikes from the plurality of input neurons to each of a plurality of E-neurons, providing 374 a plurality of second spikes from a plurality of I-neurons to the plurality of E-neurons to inhibit a spiking rate of the E-neurons, generating 376 a plurality of weights at each of the plurality of E-neurons based on the plurality of first spikes and the plurality of second spikes, and classifying 378 a pattern utilizing the plurality of input neurons, the plurality of E-neurons, and the plurality of weights at each of the E-neurons.

The method 300 comprising processing each of the plurality of base templates through the plurality of input neurons further comprises processing each of a plurality of pixels of the plurality of base templates through corresponding input neurons. Processing each of the plurality of base templates through the plurality of input neurons further comprises repetitively processing each of the plurality of base templates through the plurality of input neurons.

The method 300 comprising generating the plurality of weights at each of the plurality of E-neurons based on the plurality of first spikes and the plurality of second spikes further comprises generating a weight, from the plurality of weights, for each of a plurality of links between the plurality of E-neurons and the plurality of input neurons. The plurality of links can be feed-forward links. The plurality of E-neurons and the plurality of I-neurons can comprise a single layer of the spiking neural network.

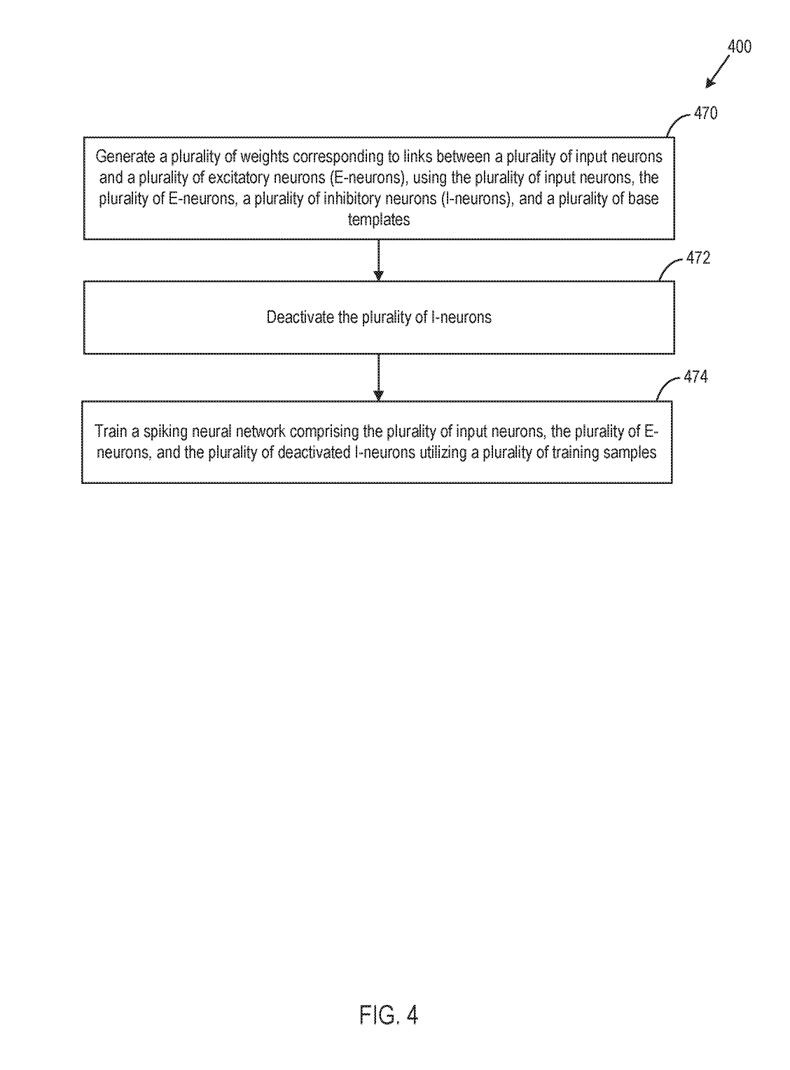

FIG. 4 is a flow diagram illustrating a method for object recognition using a spiking neural network according to various embodiments. The method 400 comprises generating 470 a plurality of weights corresponding to links between a plurality of input neurons and a plurality of E-neurons, using the plurality of input neurons, the plurality of E-neurons, a plurality of I-neurons, and a plurality of base templates, deactivating 472 the plurality of I-neurons, and training 474 a spiking neural network comprising the plurality of input neurons, the plurality of E-neurons, and the plurality of deactivated I-neurons utilizing a plurality of training samples.

The method 400 comprising training the spiking neural network further comprises generating a plurality of spiking rates, for a corresponding training sample from the plurality of training samples, by processing the corresponding training sample through the plurality of input neurons and the plurality of E-neurons. Generating a plurality of spiking rates further comprises generating a signature, for a corresponding training sample from the plurality of training samples, comprising the plurality of spiking rates. The signature can be a rate vector comprising the plurality of spiking rates.

Training the spiking neural network also comprises creating spike-rate signature for a plurality of classes to be recognized and wherein each of the plurality of classes is represented by a number of training samples. Generating the plurality of classes for the plurality of training samples further comprises generating a plurality of signatures from the plurality of training samples, wherein each of the plurality of signatures comprises a rate vector of the E-neurons. The method 40 can further comprise storing the plurality of classes in a memory of an auxiliary CPU.

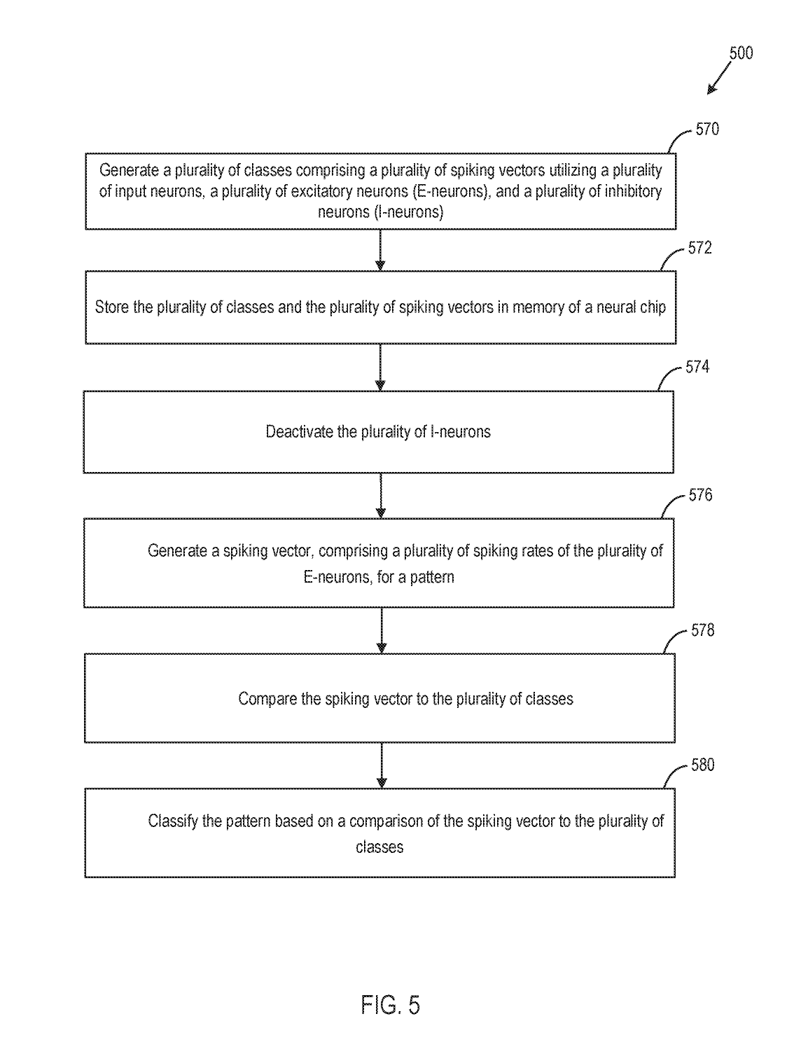

FIG. 5 is a flow diagram illustrating a method for object recognition using a spiking neural network according to various embodiments. The method 500 comprises generating 570 a plurality of classes comprising a plurality of spiking vectors utilizing a plurality of input neurons, a plurality of E-neurons, and a plurality of I-neurons, storing 572 the plurality of classes and the plurality of spiking vectors in memory of a neural chip, deactivating 574 the plurality of I-neurons, generating 576 a spiking vector, comprising a plurality of spiking rates of the plurality of E-neurons, for a pattern, comparing 578 the spiking vector to the plurality of classes, and classifying 580 the pattern based on a comparison of the spiking vector to the plurality of classes.

The memory of the neural chip can be hosted by an auxiliary CPU of the neural chip. Comparing the spiking vector to the plurality of classes can further comprise comparing the spiking vector to the plurality of spiking vectors corresponding to the plurality of classes. Classifying the pattern can further comprise determining a distance from the spiking vector to corresponding spiking vectors of a particular class from the plurality of classes. Classifying the pattern further comprises assigning a class, from the plurality of classes, to the pattern, wherein the class has a smallest distance between the spiking vector and the corresponding spiking vectors of the class. The method 500 further comprises determining whether the pattern is correctly assigned to the class. The method also further comprises determining a correct class from the plurality of classes of the pattern based on a determination that the pattern is not correctly assigned. The method 500 also comprises adding the spiking vector to the corresponding spiking vectors of the correct class.

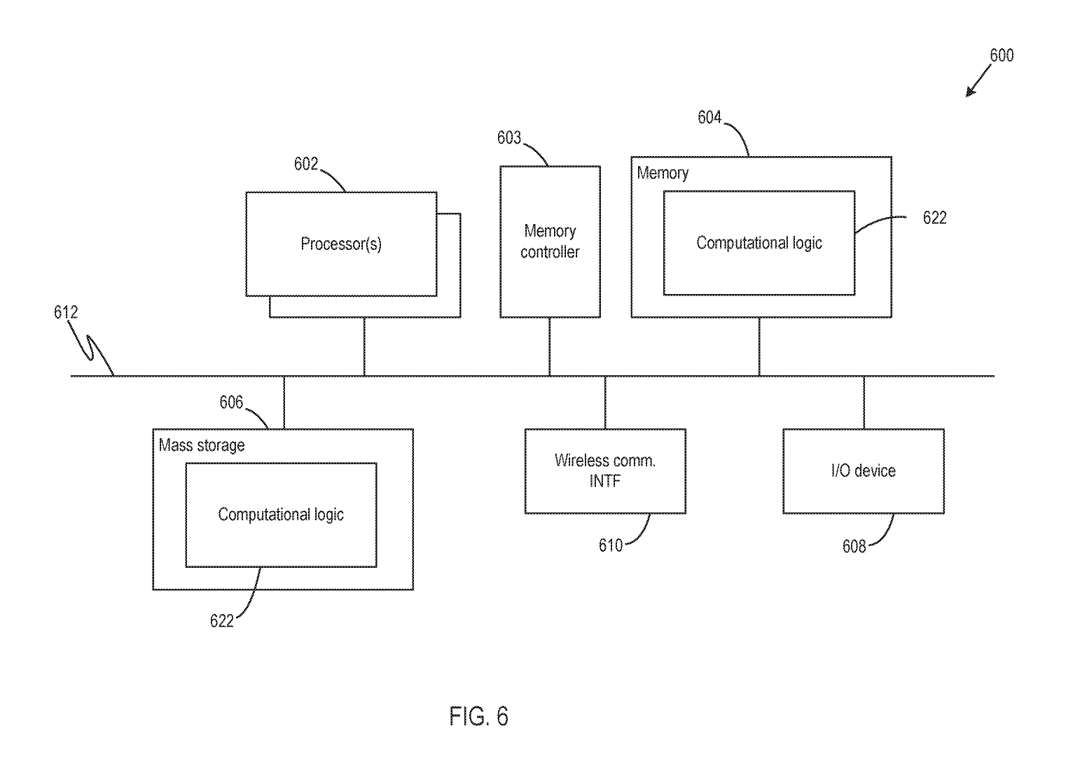

FIG. 6 illustrates an example of a computing device 600 suitable for use to practice aspects of the present disclosure, according to various embodiments. As shown, the computing device 600 may include one or more processors 602, each with one or more processor cores, system memory 604, and a memory controller 603. The system memory 604 may be any volatile or non-volatile memory. Additionally, the computing device 600 may include mass storage devices 606. Examples of the mass storage devices 606 may include, but are not limited to, tape drives, hard drives, compact disc read-only memory (CD-ROM), and so forth. Further, the computing device 600 may include input/output devices 608 (such as display, keyboard, cursor control, and so forth) and communication interfaces 610 (such as wireless and/or wired communication/network interface cards, modems, and so forth). The elements may be coupled to each other via a system bus 612, which may represent one or more buses. In the case of multiple buses, they may be bridged by one or more bus bridges (not shown).

Each of these elements may perform its conventional functions known in the art. The system memory 604 and the mass storage devices 606 may be employed to store a working copy and a permanent copy of the programming instructions implementing a number of operations referred to as computational logic 622. The memory controller 603 may include internal memory to store a working copy and a permanent copy of the programming instructions implementing a number of operations associated with object recognition using a spiking neural network. The computational logic 622 may be implemented by assembler instructions supported by the processor(s) 602 or high-level languages, such as, for example, C, that can be compiled into such instructions.

The number, capability, and/or capacity of the communication interfaces 610 and the system bus 612 may vary, depending on whether the computing device 600 is used as a mobile device, such as a wearable device, a smartphone, a computer tablet, a laptop, and so forth, or a stationary device, such as a desktop computer, a server, a game console, a set-top box, an infotainment console, and so forth. Otherwise, the constitutions of the communication interfaces 610 and the system bus 612 are known, and accordingly will not be further described.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module,” or “system.” Furthermore, the present disclosure may take the form of a computer program product embodied in any tangible or non-transitory medium of expression having computer-usable program code embodied in the medium.

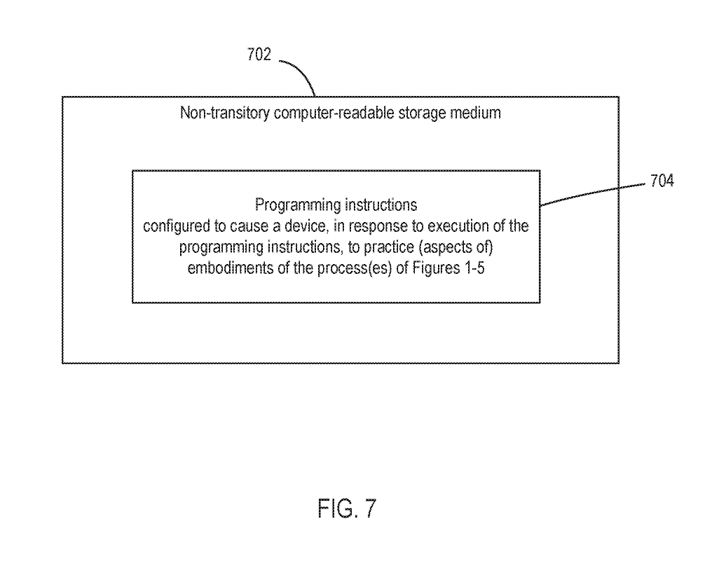

FIG. 7 illustrates an example non-transitory computer-readable storage medium 702 that may be suitable for use to store instructions that cause an apparatus, in response to execution of the instructions by the apparatus, to practice selected aspects of the present disclosure. As shown, the non-transitory computer-readable storage medium 702 may include a number of programming instructions 704. The programming instructions 704 may be configured to enable a device (e.g., the computing device 600 in FIG. 6) in response to execution of the programming instructions 704, to implement (aspects of) the spiking neural networks 100 and 200 in FIGS. 1 and 2, respectively, as earlier described. In alternative embodiments, the programming instructions 704 may be disposed on multiple non-transitory computer-readable storage media 702, such as signals, instead.

Any combination of one or more computer-usable or computer-readable medium(s) may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++, or the like and conventional procedural programming languages, such as the “C” programming language or similar programming languages. The program code may execute entirely on the user's computer; partly on the user's computer, as a stand-alone software package; partly on the user's computer and partly on a remote computer; or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an,” and “the” are intended to include plural forms as well, unless the context clearly indicates otherwise. It will be further understood that the terms “comprises” and/or “comprising,” when used in this specification, are specific to the presence of stated features, integers, steps, operations, elements, and/or components, but do not preclude the presence or addition of one or more other features, integers, steps, operation, elements, components, and/or groups thereof.

Embodiments may be implemented as a computer process, a computing system, or an article of manufacture such as a computer program product of computer-readable media. The computer program product may be a computer storage medium readable by a computer system and encoding computer program instructions for executing a computer process.

The corresponding structures, materials, acts, and equivalents of all means or steps plus function elements in the claims below are intended to include any structure, material, or act for performing the function in combination with other claimed elements that are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

Referring back to FIG. 6, for one embodiment, at least one of the processors 602 may be packaged together with memory, as earlier described. For one embodiment, at least one of the processors 602 may be packaged together with memory, to form a System in Package (SiP). For one embodiment, at least one of the processors 602 may be integrated on the same die with memory. For one embodiment, at least one of the processors 602 may be packaged together with memory to form a System on Chip (SoC). For at least one embodiment, the SoC may be utilized in, e.g., but not limited to, a wearable device, a smartphone or a computing tablet. Thus various example embodiments of the present disclosure have been described, including but are not limited to:

Example 1 is an apparatus for object recognition using a spiking neural network. The apparatus includes electronic memory to store a variety of base templates. The apparatus also includes one or more processors designed to process each of the variety of base templates through a variety of input neurons to generate a variety of first spikes through the variety of input neurons, provide the variety of first spikes from the variety of input neurons to each of a variety of excitatory neurons (E-neurons), and provide a variety of second spikes from a variety of inhibitory neurons (I-neurons) to the variety of E-neurons to inhibit a spiking rate of the E-neurons. The apparatus also includes one or more processors designed to generate a variety of weights at each of the variety of E-neurons based on the variety of first spikes and the variety of second spikes, and classify a pattern utilizing the variety of input neurons, the variety of E-neurons, and the variety of weights at each of the E-neurons.

Example 2 is the apparatus of Example 1, where the one or more processors designed to process each of the variety of base templates through the variety of input neurons are further designed to process each of a variety of pixels of the variety of base templates through corresponding input neurons.

Example 3 is the apparatus of Example 1, where the one or more processors designed to process each of the variety of base templates through the variety of input neurons are further designed to repetitively process each of the variety of base templates through the variety of input neurons.

Example 4 is the apparatus of Example 1, where the one or more processors designed to generate the variety of weights at each of the variety of E-neurons based on the variety of first spikes and the variety of second spikes are further designed to generate a weight, from the variety of weights, for each of a variety of links between the variety of E-neurons and the variety of input neurons.

Example 5 is the apparatus of Example 4, where the variety of links are feed-forward links.

Example 6 is the apparatus of Example 1, where the variety of E-neurons and the variety of I-neurons include a single layer of the spiking neural network.

Example 7 is a computer-readable storage medium. The computer-readable storage medium having stored thereon instructions that, when implemented by a computing device, cause the computing device to generate a variety of weights corresponding to links between a variety of input neurons and a variety of excitatory neurons (E-neurons), using the variety of input neurons, the variety of E-neurons, a variety of inhibitory neurons (I-neurons), and a variety of base templates. The computer-readable storage medium having stored thereon instructions that, when implemented by a computing device, cause the computing device to deactivate the variety of I-neurons, and train a spiking neural network including the variety of input neurons, the variety of E-neurons, and the variety of deactivated I-neurons utilizing a variety of training samples.

Example 8 is the computer-readable storage medium of Example 7, where the instructions to train the spiking neural network further include instructions to generate a variety of spiking rates, for a corresponding training sample from the variety of training samples, by processing the corresponding training sample through the variety of input neurons and the variety of E-neurons.

Example 9 is the computer-readable storage medium of Example 8, where the instructions to generate a variety of spiking rates further include instructions to generate a signature, for a corresponding training sample from the variety of training samples, including the variety of spiking rates.

Example 10 is the computer-readable storage medium of Example 9, where the signature is a rate vector including the variety of spiking rates.

Example 11 is the computer-readable storage medium of Example 7, where the instructions to train the spiking neural network also include instructions to create spike-rate signature for a variety of classes to be recognized and where each of the variety of classes is represented by a number of training samples.

Example 12 is the computer-readable storage medium of Example 11, where the instructions to generate the variety of classes for the variety of training samples further include instructions to generate a variety of signatures from the variety of training samples, where each of the variety of signatures includes a rate vector of the E-neurons.

Example 13 is the computer-readable storage medium of Example 12, where the instructions further include instructions to store the variety of classes in a memory of an auxiliary central processing unit (CPU).

Example 14 is a method for generating a spiking neural network. The method includes generating a variety of classes including a variety of spiking vectors utilizing a variety of input neurons, a variety of excitatory neurons (E-neurons), and a variety of inhibitory neurons (I-neurons), storing the variety of classes and the variety of spiking vectors in memory of a neural chip, and deactivating the variety of I-neurons. The method also includes generating a spiking vector, including a variety of spiking rates of the variety of E-neurons, for a pattern, comparing the spiking vector to the variety of classes, and classifying the pattern based on a comparison of the spiking vector to the variety of classes.

Example 15 is the method of Example 14, where the memory of the neural chip is hosted by an auxiliary central processing unit (CPU) of the neural chip.

Example 16 is the method of Example 14, where comparing the spiking vector to the variety of classes further includes comparing the spiking vector to the variety of spiking vectors corresponding to the variety of classes.

Example 17 is the method of Example 16, where classifying the pattern further includes determining a distance from the spiking vector to corresponding spiking vectors of a particular class from the variety of classes.

Example 18 is the method of Example 17, where classifying the pattern further includes assigning a class, from the variety of classes, to the pattern, where the class has a smallest distance between the spiking vector and the corresponding spiking vectors of the class.

Example 19 is the method of Example 18, further including determining whether the pattern is correctly assigned to the class.

Example 20 is the method of Example 19, further including determining a correct class from the variety of classes of the pattern based on a determination that the pattern is not correctly assigned.

Example 21 is the method of Example 20, further including adding the spiking vector to the corresponding spiking vectors of the correct class.

Example 22 is a method for generating a spiking neural network. The method includes processing each of a variety of base templates through a variety of input neurons to generate a variety of first spikes through the variety of input neurons, providing the variety of first spikes from the variety of input neurons to each of a variety of excitatory neurons (E-neurons), and providing a variety of second spikes from a variety of inhibitory neurons (I-neurons) to the variety of E-neurons to inhibit a spiking rate of the E-neurons. The method also includes generating a variety of weights at each of the variety of E-neurons based on the variety of first spikes and the variety of second spikes, and classifying a pattern utilizing the variety of input neurons, the variety of E-neurons, and the variety of weights at each of the E-neurons.

Example 23 is the method of Example 22, where processing each of the variety of base templates through the variety of input neurons further includes processing each of a variety of pixels of the variety of base templates through corresponding input neurons.

Example 24 is the method of Example 22, where processing each of the variety of base templates through the variety of input neurons further includes repetitively processing each of the variety of base templates through the variety of input neurons.

Example 25 is the method of Example 22, where generating the variety of weights at each of the variety of E-neurons based on the variety of first spikes and the variety of second spikes further includes generating a weight, from the variety of weights, for each of a variety of links between the variety of E-neurons and the variety of input neurons.

Example 26 is the method of Example 25, where the variety of links are feed-forward links.

Example 27 is the method of Example 22, where the variety of E-neurons and the variety of I-neurons include a single layer of the spiking neural network.

Example 28 is a method for generating a spiking neural network. The method includes generating a variety of weights corresponding to links between a variety of input neurons and a variety of excitatory neurons (E-neurons), using the variety of input neurons, the variety of E-neurons, a variety of inhibitory neurons (I-neurons), and a variety of base templates. The method includes deactivating the variety of !-neurons and training a spiking neural network including the variety of input neurons, the variety of E-neurons, and the variety of deactivated I-neurons utilizing a variety of training samples.

Example 29 is the method of Example 28, where training the spiking neural network further includes generating a variety of spiking rates, for a corresponding training sample from the variety of training samples, by processing the corresponding training sample through the variety of input neurons and the variety of E-neurons.

Example 30 is the method of Example 29, where generating a variety of spiking rates further includes generating a signature, for a corresponding training sample from the variety of training samples, including the variety of spiking rates.

Example 31 is the method of Example 30, where the signature is a rate vector including the variety of spiking rates.

Example 32 is the method of Example 28, where training the spiking neural network also includes creating spike-rate signature for a variety of classes to be recognized and where each of the variety of classes is represented by a number of training samples.

Example 33 is the method of Example 32, where generating the variety of classes for the variety of training samples further includes generating a variety of signatures from the variety of training samples, where each of the variety of signatures includes a rate vector of the E-neurons.

Example 34 is the method of Example 33, further includes storing the variety of classes in a memory of an auxiliary central processing unit (CPU).

As used herein, the term “module” may refer to, be part of, or include an application specific integrated circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

It will be obvious to those having skill in the art that many changes may be made to the details of the above-described embodiments without departing from the underlying principles of the invention. The scope of the present invention should, therefore, be determined only by the following claims.

1. An apparatus for object recognition using a spiking neural network, comprising:
electronic memory to store a plurality of base templates; and
one or more processors configured to:
process each of the plurality of base templates through a plurality of input neurons to generate a plurality of first spikes through the plurality of input neurons;
provide the plurality of first spikes from the plurality of input neurons to each of a plurality of excitatory neurons (E-neurons);
provide a plurality of second spikes from a plurality of inhibitory neurons (I-neurons) to the plurality of E-neurons to inhibit a spiking rate of the E-neurons;
generate a plurality of weights at each of the plurality of E-neurons based on the plurality of first spikes and the plurality of second spikes; and
classify a pattern utilizing the plurality of input neurons, the plurality of E-neurons, and the plurality of weights at each of the E-neurons.

2. The apparatus of claim 1, wherein the one or more processors configured to process each of the plurality of base templates through the plurality of input neurons are further configured to process each of a plurality of pixels of the plurality of base templates through corresponding input neurons.

3. The apparatus of claim 1, wherein the one or more processors configured to process each of the plurality of base templates through the plurality of input neurons are further configured to repetitively process each of the plurality of base templates through the plurality of input neurons.

4. The apparatus of claim 1, wherein the one or more processors configured to generate the plurality of weights at each of the plurality of E-neurons based on the plurality of first spikes and the plurality of second spikes are further configured to generate a weight, from the plurality of weights, for each of a plurality of links between the plurality of E-neurons and the plurality of input neurons.

5. The apparatus of claim 4, wherein the plurality of links are feed-forward links.

6. The apparatus of claim 1, wherein the plurality of E-neurons and the plurality of I-neurons comprise a single layer of the spiking neural network.

7. A computer-readable storage medium having stored thereon instructions that, when implemented by a computing device, cause the computing device to:
generate a plurality of weights corresponding to links between a plurality of input neurons and a plurality of excitatory neurons (E-neurons), using the plurality of input neurons, the plurality of E-neurons, a plurality of inhibitory neurons (I-neurons), and a plurality of base templates;
deactivate the plurality of I-neurons; and
train a spiking neural network comprising the plurality of input neurons, the plurality of E-neurons, and the plurality of deactivated I-neurons utilizing a plurality of training samples.

8. The computer-readable storage medium of claim 7, wherein the instructions to train the spiking neural network further comprise instructions to:
generate a plurality of spiking rates, for a corresponding training sample from the plurality of training samples, by processing the corresponding training sample through the plurality of input neurons and the plurality of E-neurons.

9. The computer-readable storage medium of claim 8, wherein the instructions to generate a plurality of spiking rates further comprise instructions to generate a signature, for a corresponding training sample from the plurality of training samples, comprising the plurality of spiking rates.

10. The computer-readable storage medium of claim 9, wherein the signature is a rate vector comprising the plurality of spiking rates.

11. The computer-readable storage medium of claim 7, wherein the instructions to train the spiking neural network also comprise instructions to create spike-rate signature for a plurality of classes to be recognized and wherein each of the plurality of classes is represented by a number of training samples.

12. The computer-readable storage medium of claim 11, wherein the instructions to generate the plurality of classes for the plurality of training samples further comprise instructions to generate a plurality of signatures from the plurality of training samples, wherein each of the plurality of signatures comprises a rate vector of the E-neurons.

13. The computer-readable storage medium of claim 12, wherein the instructions further comprise instructions to store the plurality of classes in a memory of an auxiliary central processing unit (CPU).

14. A method for generating a spiking neural network, comprising:
generating a plurality of classes comprising a plurality of spiking vectors utilizing a plurality of input neurons, a plurality of excitatory neurons (E-neurons), and a plurality of inhibitory neurons (I-neurons);
storing the plurality of classes and the plurality of spiking vectors in memory of a neural chip;
deactivating the plurality of I-neurons;
generating a spiking vector, comprising a plurality of spiking rates of the plurality of E-neurons, for a pattern;
comparing the spiking vector to the plurality of classes; and
classifying the pattern based on a comparison of the spiking vector to the plurality of classes.

15. The method of claim 14, wherein the memory of the neural chip is hosted by an auxiliary central processing unit (CPU) of the neural chip.

16. The method of claim 14, wherein comparing the spiking vector to the plurality of classes further comprises comparing the spiking vector to the plurality of spiking vectors corresponding to the plurality of classes.

17. The method of claim 16, wherein classifying the pattern further comprises determining a distance from the spiking vector to corresponding spiking vectors of a particular class from the plurality of classes.

18. The method of claim 17, wherein classifying the pattern further comprises assigning a class, from the plurality of classes, to the pattern, wherein the class has a smallest distance between the spiking vector and the corresponding spiking vectors of the class.

19. The method of claim 18, further comprising determining whether the pattern is correctly assigned to the class.

20. The method of claim 19, further comprising determining a correct class from the plurality of classes of the pattern based on a determination that the pattern is not correctly assigned.

21. The method of claim 20, further comprising adding the spiking vector to the corresponding spiking vectors of the correct class.
